(19) United States
(12) Patent Application Publication
(10) Pub. No.: US 2014/0284953 A1
(43) Pub. Date: Sep. 25, 2014

(54) INTERIOR FITTING PART HAVING PLANT-BASED NATURAL PRODUCTS

(71) Applicants: Sreenivas Paruchuri, Eastbourne (GB); Holger Kalus, Duisburg (DE)

(72) Inventors: Sreenivas Paruchuri, Eastbourne (GB); Holger Kalus, Duisburg (DE)

(73) Assignee: Johnson Controls Interiors GmbH & Co. KG

(21) Appl. No.: 14/237,333

(22) PCT Filed: Jun. 27, 2012
(86) PCT No.: PCT/EP2012/002703

§ 371 Date: May 27, 2014

(30) Foreign Application Priority Data
Aug. 5, 2011 (DE) 10 2011 109 555.5
Aug. 11, 2011 (DE) 10 2011 109 979.8

(51) Int. Cl. B60R 13/02; B29C 65/70

(52) U.S. Cl. CPC B60R 13/02; B29C 65/70
USPC 296/1.08; 156/245

(57) ABSTRACT

A fitting part for the interior of a motor vehicle includes a backing manufactured from a material having at least one natural substance, a decorative layer made of a material having natural fibers that cover at least part of a visible side of the backing, and a transparent or translucent outer layer provided at least in part on the backing and/or the decorative layer.

The invention relates to a fitting-out part for the interior of a motor vehicle, and also to a process for the production of a fitting-out part.

The international patent application WO 2010/080967 A1 discloses a fitting-out part with a backing made of natural fibers and a transparent outer foil which is applied on the surface of the backing without use of additional hot-melt adhesives.

The invention is based on the object of providing a fitting-out part which is visually attractive, and which also has good properties in respect of scratch resistance, UV resistance, and costs. A further intention is to provide a process for the efficient production of fitting-out parts whose price represents good value and which are visually attractive.

The object is achieved via a fitting-out part which
comprises a backing manufactured from a material which is preferably plant-based but which also comprises any desired natural substances,
where a decorative layer made of a material comprising natural, preferably plant-based, fibers preferably covers at least part of the visible side of the backing, and
where the backing and/or the decorative layer has been provided at least in part with a transparent or translucent outer layer.

The description provided relating to this subject matter of the present invention applies equally to the other subject matter of the present invention, and vice versa.

The backing preferably comprises, as natural substance, wood fibers or wood particles respectively bonded to one another by way of a binder. The binder is preferably an acrylic resin that hardens in the manner of a thermoset. Synthetic fibers, in particular made of polyester, can moreover be admixed with the backing material in order to raise strength. The proportion of natural substance is preferably from 50 to 85% by weight, in particular about 70% by weight. The proportion of binder is preferably below 50% by weight, in particular about 15% by weight. In one preferred embodiment, the proportion of synthetic fibers is from 10 to 20% by weight, in particular about 15% by weight.

The form in which the backing material, in particular the natural substance, is introduced to the further process(es) is preferably that of a mat which can be pressed and/or which has been needled.

In another preferred embodiment, the backing comprises a natural substance, in particular flax, hemp and/or kenaf, particular preference being given here to kenaf, and comprises, as binder, a thermoplastic, in particular polypropylene. This embodiment of the present invention has the advantage that it is preferably possible to omit any decorative layer. The visible side of the backing is preferably covered by the transparent or translucent outer layer. The form in which the thermoplastic binder is provided is likewise preferably that of fiber material. It is preferable that the backing is composed of from 40 to 60% by weight of natural fiber and from 60 to 40% by weight of thermoplastic binder. Alternatively or in addition, however, it is also possible to use coconut fibers and/or animal bristles for the backing layer. The fibers advantageously take the form of random fibers, for example take the form of non-woven.

It is moreover advantageous to add, to the backing material, in particular the natural substance, at least one additive which increases the thermal stability of the natural substance during processing and/or which provides adequate colorfastness and/or lifetime during irradiation with light at high temperatures. The backing in essence determines the mechanical properties of the fitting-out part. However, another advantageous possibility is that the natural fibers, the binder, and/or the synthetic fibers of the backing are colored identically or differently, preferably before they are bonded.

The price of the backing represents good value by virtue of the composition of materials therein, but the backing is sometimes not very visually attractive; it is preferably at least to some extent covered by the decorative layer. Accordingly, in an alternative, the visible side of the backing has a covering decorative layer, and said decorative layer, to the extent that it is present, can cover the visible side of the backing to some extent or completely. The decorative-layer material advantageously comprises bast fibers, for example flax, hemp, kenaf or the like. Alternatively or in addition, however, it is also possible to use coconut fibers and/or animal bristles. The diameter of the fibers is preferably from 5 to 40 μm. The length of the fibers is preferably from 1000 to 6000 μm. The fibers advantageously take the form of random fibers, for example non-woven or felt, and preference is also given here to an arrangement in woven fabrics or in knitted fabrics. The backing material moreover comprises a binder, preferably an acrylic resin that hardens in the manner of a thermoset. The proportion of fiber in the decorative layer is preferably from 70 to 90% by weight, in particular from 80 to 85% by weight.

The proportion of binder is preferably below 30% by weight, in particular below 20% by weight. In order to influence mechanical properties, it is optionally possible to add a proportion which is preferably less than 10% by weight of synthetic fibers, in particular made of polyester. It is moreover advantageous to add, to the decorative layer material, at least one additive which increases the thermal stability of the natural fibers during processing, and which also increases resistance to UV radiation. Suitable additives are by way of example light stabilizers such as 4-hydroxy-2,2,6,6-tetramethylpiperidinoxyl or UV absorbers such as sulfonated benzotriazole, and these can in each case be used individually or in combination. The decorative layer can in essence determine the optical properties of the fitting-out part. The natural fibers, the binder, and/or the synthetic fibers of the decorative layer are therefore advantageously colored identically or differently, preferably prior to bonding thereof.

The binder of the backing or of the decorative layer is advantageously composed of a thermoplastic, for example of polypropylene (PP), acrylic-butadiene-styrene (ABS), polycarbonate (PC), and/or a PC/ABS blend.

Natural fibers or natural substance used can be by way of example wood, kenaf, hemp, flax, abaca, sisal or similar plants with a bast-fiber stem. For further information relating to these fibers or natural substances reference is made to the publication “Industrial Applications of Natural Fibres”, Wiley-Verlag, pages 25 and 26. Said passage is hereby incorporated by way of reference and is therefore considered to be part of this disclosure.

The form in which the natural fibers or the natural substance are/is processed can by way of example be that of individual fibers or that of mats or non-wovens. The fibers, for example the mats or non-wovens, can by way of example have been hydroconsolidated or thermally bonded, and/or needle felts. In one preferred embodiment the fiber layer is coated with a transparent backing medium. The fiber layer, for example mat and/or non-woven, is preferably subsequently subjected to a forming process, particularly preferably via pressing. It is moreover preferable that the fibers have been embedded into granulated materials which are processed via injection molding to give a fitting-out part.

The outer layer is advantageously composed of a plastics foil that is at least to some extent transparent or at least to some extent translucent. The plastics foil can advantageously be composed of a thermoplastic polyurethane (TPU), of polypropylene (PP) with a polyurethane coating on the visible side, or of polyamide (PA) or of polycarbonate (PC). The thickness of a suitable foil can by way of example be from 20 μm to 500 μm. Suitable foil materials are PP, polymethyl methacrylate (PMMA), ABS, PC or PC/ABS. It is also advantageous to apply, to the foil, a coating-material layer which is advantageously composed of a crosslinkable polyurethane, and the thickness of which is preferably from 5 μm to 50 μm. Added to the outer-layer material there are moreover additives which increase resistance to UV radiation. In one particular embodiment of the invention, the outer layer is colored, and this color can correspond to, or deviate from, the coloring of the decorative layer.

It is preferable that UV protection has been provided, individually or in combination, to a component of the fitting-out part, for example the natural fibers, the non-woven, the binder, and/or the outer layer, for example the foil.

In a first preferred embodiment, the forming process to give a three-dimensional fitting-out part takes place only after the application of the surface protection to the layer provided with a mat and/or with a non-woven and/or with other natural fibers, in particular to the decorative layer. In another preferred embodiment, the surface protection is provided only after the decorative layer provided with a mat and/or with a non-woven and/or with other natural fibers has been subjected to the forming process. A grained effect can be achieved on the surface by applying grained surface protection, for example a grained outer layer, in particular a grained outer-layer foil, or via a grained effect in the mold. Said grained effect in the mold is embossed into the outer layer and/or into the decorative layer.

It is moreover advantageous that the fitting-out part comprises, in the visible region below the surface protection, for example below the outer layer, in particular in the decorative layer, further, preferably colored, content of natural substances, for example leaves, grasses, horn, cork, or the like.

The thickness of the backing is advantageously from 1.5 to 3.0 mm, in particular about 2.0 mm, and the weight per unit area of the backing here is preferably from 1000 to 1600 g/m², in particular about 1400 g/m².

The thickness of the decorative layer is advantageously from 0.1 to 1.0 mm, in particular about 0.2 to 0.3 mm, and the weight per unit area of the decorative layer here is preferably from 200 to 500 g/m², in particular from 300 to 400 g/m².

The thickness of the outer layer is advantageously from 0.03 mm to 0.50 mm, in particular from 0.05 to 0.20 mm.

In the production of the fitting-out part, it is preferable that a semifinished product in the form of a mat for the backing, a semifinished product in the form of a mat for the decorative layer, and also the outer layer, are placed on top of one another and pressed to give a two- or three-dimensional component with introduction of heat, but preferably without use of any additional adhesives.

Alternatively, in particular in the case of fitting-out parts of very distinctly three-dimensional shape, it is possible to bond the decorative layer and the outer layer to one another initially to give a multilayer sheet-like structure, and then to bond these to the backing. The application to the backing can be achieved by way of example via lamination or overmolding, in particular with a material comprising a thermoset binder. Prior to the bonding to the backing, it is particularly advantageous to subject the composite made of decorative layer and outer layer to a preforming process, in particular via thermoforming.

In a particular embodiment of the production of the fitting-out part, the decorative layer is moreover assembled from various, in particular differently colored segments. The segments can be abutted in such a way as to produce a discernible dividing line between the segments in the fitting-out part. However, overlapping of the segments of the decorative layer when they are applied to the backing is particularly advantageous, and if the segments have different coloring here it is possible to achieve interesting optical effects via color mixing in the transition region.

If the fitting-out part has a plurality of visible sides, it is in principle possible to cover each of said visible sides completely or to sonic extent with a decorative layer and an outer layer.

The inventions are explained below with reference to the figures. These explanations serve merely as examples, and do not restrict the general concept of the invention. The explanations apply equally to all of the subject matter.

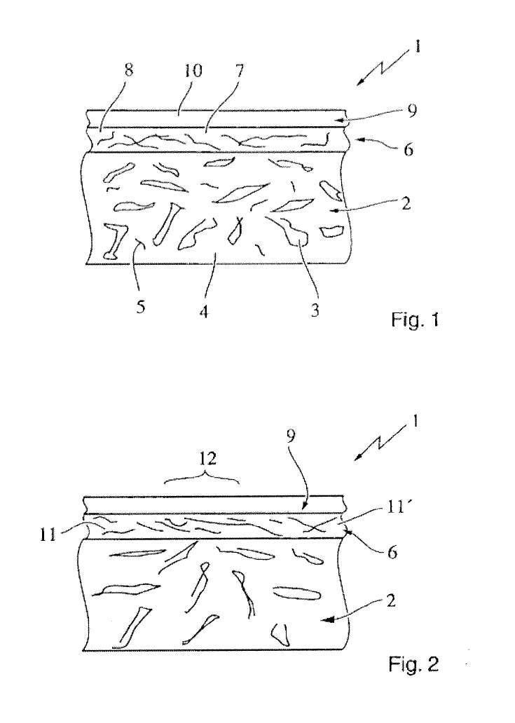

FIG. 1 shows an embodiment of the fitting-out part of the invention.

FIG. 2 shows another embodiment of the fitting-out part of the invention.

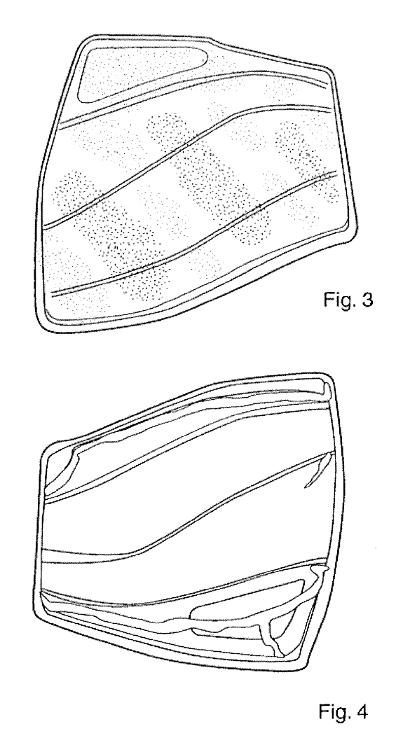

Each of FIGS. 3 and 4 shows a fitting-out part in which a decorative layer comprises a natural substance.

The fitting-out part 1 shown in FIG. 1 for a vehicle interior (e.g. door cladding, dashboard, column cladding, roof lining, panel on vehicle seat) is composed of a backing 2, the material of which here comprises relatively coarse chip-type wood particles 3. A binder 4 bonds the wood particles 3. Small amounts of synthetic fibers 5 have moreover been added to the backing material 2 in order to raise strength. A decorative layer 6 composed of comparatively long natural fibers 7 in random arrangement and of a binder 8 covers the visible side of the backing, in this case over its entire area. An outer layer 9 in the form of a transparent plastics foil 10 covers the decorative layer 6 over its entire area and preferably renders the fitting-out part scratch-resistant and/or UV-resistant. The outer layer and/or the decorative layer can have a grain effect. The person skilled in the art will understand that the decorative layer can also be omitted. In this embodiment, which is likewise inventive, the decorative layer 6 is attached directly on the visible side of the backing 2.

In the embodiment of FIG. 2, the decorative layer 6 is composed of two mutually overlapping, differently colored segments 11, 11′, which are together covered over their entire area by the outer layer 9. The overlapping region 12 here generates interesting optical effects.

FIG. 3 shows the example of a decorative layer composed of a plastics binder in a first color, of natural fibers in a second color, incorporated by bonding, and of added horn constituents in a third color. The component has transparent surface protection which is an outer layer and which renders the component scratch-resistant and UV resistant. The decorative layer can have, on its reverse side, a backing layer which increases its stability. In the present case, the decorative layer, the outer layer and optionally the backing layer are used as three-dimensionally shaped door cladding. The decorative layer is visible to the vehicle occupants through the transparent outer layer.

FIG. 4 shows a similar fitting-out part in which cork has been introduced instead of horn. In other respects, reference is made to the description of FIG. 3.

### KEY

1 Fitting-out part

2 Backing

3 Wood particles

4 Binder

5 Synthetic fibers

6 Decorative layer

7 Natural fibers

8 Binder

9 Outer layer

10 Plastics foil

11, 11′ Segment (of decorative layer)

12 Overlapping region

1. A fitting-out part comprising:
a backing manufactured from a material comprising at least one natural substance;
a decorative layer made of a material comprising natural fibers covering at least part of a visible side of the backing; and
a transparent or translucent outer layer provided at least in part on the backing and/or the decorative layer.

2. The fitting-out part as claimed in claim 1, wherein the backing comprises wood particles.

3. The fitting-out part as claimed in claim 1, wherein the backing and/or the decorative layer comprises synthetic fibers.

4. The fitting-out part as claimed in claim 3, wherein the natural substance and/or the synthetic fibers have been bonded to one another by way of a binder.

5. The fitting-out part as claimed in claim 3, wherein the synthetic fibers take the form of random fibers, or take the form of woven fabric or of knitted fabric.

6. The fitting-out part as claimed in claim 1, wherein the outer layer is a foil.

7. The fitting-out part as claimed in claim 1, wherein that the decorative layer is assembled from a plurality of segments.

8. The fitting-out part as claimed in claim 1, wherein the decorative layer further comprises a binder wherein the natural fibers and/or the binder have been colored.

9. The fitting-out part as claimed in claim 8, wherein that the natural fibers and the binder have been differently colored.

10. A process of the production of a fitting-out part as claimed in claim 1, wherein the decorative layer in the form of semifinished product and the outer layer are inserted into a mold and with introduction of heat three-dimensionally shaped and bonded to one another.

11. The process as claimed in claim 10, wherein the outer layer is subsequently or simultaneously bonded to the backing.

12. The process as claimed in claim 11, wherein the backing is applied on the outer layer via lamination or overmolding.

13. The process as claimed in claim 10, wherein, prior to application to the backing, the decorative layer and/or the outer layer is subjected to shaping.

14. The process as claimed in claim 10, wherein the decorative layer further comprises a binder, the backing and/or the decorative layer comprises synthetic fibers, and the natural fibers, the binder, and/or the synthetic fibers are colored.
